(19) United States
(12) Patent Application Publication
(10) Pub. No.: US 2022/0365210 A1
(43) Pub. Date: Nov. 17, 2022

(54) AUTONOMOUS VEHICLE THAT COMPRISES ULTRASONIC SENSORS

(71) Applicant: GM Cruise Holdings LLC, San Francisco, CA (US)

(72) Inventor: Amanda Lind, Brooklyn, NY (US)

(21) Appl. No.: 17/319,044

(22) Filed: May 12, 2021

(51) Int. Cl. G01S 15/931; G01S 15/42

(52) U.S. Cl. CPC G01S 15/931; G01S 15/42; G01S 2015/937

(57) ABSTRACT

An autonomous vehicle includes a first ultrasonic sensor and a second ultrasonic sensor that is included in a daisy chain with the first ultrasonic sensor, wherein the first ultrasonic sensor is electrically connected to the second ultrasonic sensor in the daisy chain by way of a twisted pair wire. The autonomous vehicle further includes an electronic control unit (ECU) for the first ultrasonic sensor and the second ultrasonic sensor, the ECU is included in the daisy chain with the first ultrasonic sensor and the second ultrasonic sensor, wherein the ECU is electrically connected to the first ultrasonic sensor and the second ultrasonic sensor by way of the twisted pair wire, and further wherein the ECU is in bidirectional communication with the first ultrasonic sensor and the second ultrasonic sensor by way of differential signaling over the twisted pair wire.

### BACKGROUND

A conventional vehicle (an automobile, a truck, etc.) includes ultrasonic sensors, where the ultrasonic sensors are configured to generate sensor signals that indicate whether or not an object is located proximate to the vehicle (e.g., within 3-5 meters of the vehicle) and within a “blind” spot of a driver of the vehicle. For example, when the driver of the vehicle moves the vehicle in reverse, a first ultrasonic sensor located on a bumper of the vehicle can emit an ultrasonic signal; when an object is proximate to the bumper of the vehicle, at least a portion of the ultrasonic signal reflects from the object and the same sensor or a second ultrasonic sensor detects the reflected ultrasonic signal. When a magnitude of the reflected signal is detected as being above a threshold, the vehicle is configured to output a warning to the driver that the object is proximate to the vehicle. The warning, however, typically does not inform the driver of how far away the object is from the vehicle, a location of the object relative to the vehicle, size of the object, whether the object is static or moving, etc.

Therefore, while ultrasonic sensors provide information that may be helpful to a driver of a vehicle, that information is somewhat low resolution. This at least partially due to design priorities for conventional vehicles; specifically, modern ultrasonic systems included in vehicles focus on minimizing cost to meet this limited scope, and as such are designed with the following goals prioritized: 1) limit bandwidth required between ultrasonic sensors of the vehicle and an electronic control unit (ECU) for the ultrasonic sensors; and 2) reduce an amount of inrush current to the ECU. These goals are driven by the use of particular protocols in the automotive industry for transmitting data between ultrasonic sensors and the ECU, where the protocols include the Controller Area Network (CAN) protocol, the Local Interconnect Network (LIN) protocol, and the Serial Digital Interface (SDI) 3 protocol.

These (and similar protocols) are associated with deficiencies that are not problematic for use in conventional vehicles (which are controlled by human operators). For instance, use of the protocols referenced above results in star topologies; this is not problematic for conventional vehicles, as such vehicles include a relatively small number of ultrasonic sensors due to the lack of requirement of 360-degree coverage. If, however, a vehicle was to include numerous ultrasonic sensors (e.g., dispersed around an entire periphery of the vehicle), the length of cabling between the ECU and the ultrasonic sensors may be several hundreds of meters, resulting in design complexity and weight added to the vehicle. Further, bit depth with these protocols is somewhat limited, and signals received by the ECU from ultrasonic sensors may have a relatively low signal-to-noise ratio (SNR). To address the relatively low SNR, analog gain is used in the ultrasonic sensors over a limited “listening now” window. Additionally bit depth is reduced by performing thermal compensation/geometric spreading compensation in an application specific integrated circuit (ASIC) of the ultrasonic sensors. The overall data rate is further reduced by configuring the ASICs of the ultrasonic sensors to perform cross-correlation between a detected signal and an expected signal.

Performing these two actions (thermal compensation/geometric spreading compensation and cross-correlation) in the ASIC of the ultrasonic sensors has the following negative impacts: 1) a sensor is prevented from being able to listen to multiple modulations at once; 2) the firing sequence of the sensor is slowed; and 3) data that may represent shape and speed of an object in proximity to the vehicle is discarded. While these negative impacts are acceptable in conventional vehicles, such negative impacts render ultrasonic sensors, in their current form, unsuitable for use in fully autonomous vehicles, as the output of a conventional ECU (which indicates presence of an object somewhere proximate to the vehicle) does not include sufficient information and update rate to allow for a fully autonomous vehicle to autonomously navigate around the object and/or avoid the object. Lastly, conventional automotive ultrasonics do not enable steering or adjustable directivity, so overall thresholds need to be reduced to be robust to different intensities of ground reflection (gravel vs, pavement).

### SUMMARY

The following is a brief summary of subject matter that is described in greater detail herein. This summary is not intended to be limiting as to scope of the claims.

Described herein are various technologies pertaining to use of ultrasonic sensors in fully autonomous vehicles (e.g., level 5 autonomous vehicles), where the ultrasonic sensors are configured to provide information that is indicative of locations and types of objects that may be within 0-15 meters of the autonomous vehicle. In an example, and in contrast to conventional architecture, numerous ultrasonic sensors are electrically coupled in a bus topology with one another and with an electronic control unit (ECU) for the ultrasonic sensors, such that the ultrasonic sensors and the ECU are included in a daisy chain. With more specificity, the ultrasonic sensors and the ECU are electrically coupled in series by way of a twisted pair wire, and the ECU transmits data to and receives data from the ultrasonic sensors over the twisted pair wire by way of a communications protocol that employs differential signaling over the twisted pair wire. In an example, the communications protocol employs low voltage differential signaling (LVDS). In a specific example, the protocol is the A²B protocol of Analog Devices, Inc. (ADI).

Such architecture enables various functionalities that are not possible with conventional ultrasonic sensor architectures. Specifically, the twisted pair wire and corresponding protocol addresses bandwidth limitations associated with protocols and cabling conventionally used in automobiles, and therefore the following functionalities are enabled: 1) high-resolution signals from numerous ultrasonic sensors can be transmitted to the ECU, and the ECU can perform cross-correlation on any combination of these high-resolution signals; 2) the ECU can cause ultrasonic sensors to emit ultrasonic signals that include information that identifies the ultrasonic sensors that emitted the ultrasonic signals; and 3) Doppler information is included in detected (reflected signals), and the ECU can compute relative velocity of an object in proximity to the autonomous vehicle based upon the Doppler information.

Moreover, configuring the ECU to perform cross-correlation computations (instead of on the ASIC of an ultrasonic sensor) means that a single ultrasonic sensor is able to constantly receive reflected signals, and is further able to receive and distinguish multiple reflected signals simultaneously, resulting in creation of more data points than is possible using conventional ultrasonic sensor architectures and reduced latency when compared to conventional ultrasonic sensor architectures, which (due to Kalman filtering or other post processing) results in improved detection and localization precision when compared to conventional ultrasonic sensor architectures.

The above summary presents a simplified summary in order to provide a basic understanding of some aspects of the systems and/or methods discussed. herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic that illustrates a daisy chain of ultrasonic sensors in an autonomous vehicle.

FIG. 2 is a schematic that illustrates an arrangement of ultrasonic sensors around a periphery of an autonomous vehicle.

FIG. 3 is a schematic that illustrates another arrangement of ultrasonic sensors around a periphery of an autonomous vehicle.

FIG. 4 is a functional block diagram of an autonomous vehicle.

FIG. 5 is a flow diagram illustrating a methodology for electrically coupling ultrasonic sensors to an electronic control unit (ECU) in an autonomous vehicle.

FIG. 6 is a flow diagram illustrating a methodology for cross-correlating, at an ECU, time-series signals emitted by a pair of ultrasonic sensors of an autonomous vehicle.

FIG. 7 is a flow diagram illustrating a methodology for computing a location of an object relative to an autonomous vehicle based upon codes included in ultrasonic signals emitted by ultrasonic sensors of an autonomous vehicle.

FIG. 8 is a computing system that may be included in an autonomous vehicle.

### DETAILED DESCRIPTION

Various technologies pertaining to an autonomous vehicle that includes ultrasonic sensors and an electronic control unit (ECU) for the ultrasonic sensors are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Described herein is an autonomous vehicle that includes numerous ultrasonic sensors that are electrically coupled to one another in series and are further electrically coupled in series to an electronic control unit (ECU) for the ultrasonic sensors. Thus, the numerous ultrasonic sensors and the ECU are included in a daisy chain and are electrically coupled to one another by way of a twisted pair wire. The ECU is in bidirectional communication with the ultrasonic sensors over the twisted pair wire by way of a communications protocol that employs differential signaling in connection with transmitting communications between coupled elements. For example, the communications protocol employs low voltage differential signaling (LVDS). In another example, the communications protocol is the A²B protocol as set forth by Analog Devices, Inc. (ADI). In still yet another example, the communications protocol is Ethernet, although any suitable protocol that can be used in connection with communicating over twisted pair wire is contemplated. As will be described in greater detail herein, such architecture allows for ultrasonic sensors to be employed to provide near-field information (e.g., within 15 meters) for an autonomous vehicle (e.g., a level 5 fully autonomous vehicle).

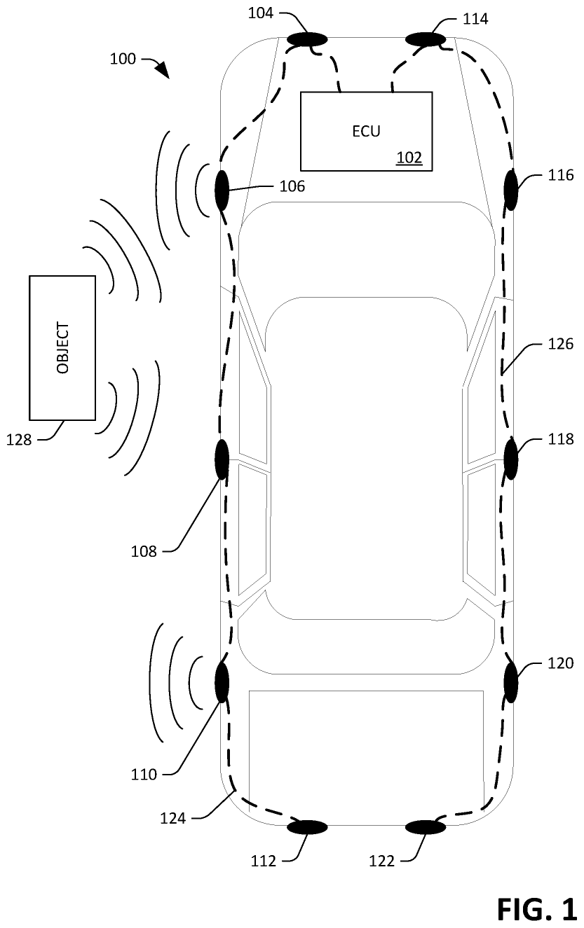

Referring now to FIG. 1, an autonomous vehicle 100 is depicted. The autonomous vehicle 100 includes an electronic control unit (ECU) 102 and ultrasonic sensors 104-122 that are electrically coupled in series to the ECU 102. In the example illustrated in FIG. 1, the ECU 102 is included in a first daisy chain with the ultrasonic sensors 104-112 and is included in a second daisy chain with the ultrasonic sensors 114-122. Thus, the ECU 102 is electrically coupled in series to the first ultrasonic sensor 104, the second ultrasonic sensor 106, the third ultrasonic sensor 108, the fourth ultrasonic sensor 110, and the fifth ultrasonic sensor 112, and the ultrasonic sensors 104-112 are electrically coupled in series with one another. Likewise, the ECU 102 is electrically coupled in series to the sixth ultrasonic sensor 114, the seventh ultrasonic sensor 116, the eighth ultrasonic sensor 118, the ninth ultrasonic sensor 120, and the tenth ultrasonic sensor 122, and the ultrasonic sensors 114-122 are electronically coupled in series with one another. While the autonomous vehicle 100 is illustrated as including two different daisy chains that each include several ultrasonic sensors, it is to be understood that the autonomous vehicle 100 may include a single daisy chain that includes ultrasonic sensors coupled to the ECU 102 or may include more than two daisy chains of ultrasonic sensors coupled to the ECU 102.

The ECU 102 and the ultrasonic sensors 104-112 are electrically coupled in series by way of a first twisted pair wire 124, and the ECU 102 and the ultrasonic sensors 114-122 are electrically coupled in series by way of a second twisted pair wire 126. Further, the ECU 102 is in bidirectional communication with the ultrasonic sensors 104-122 over the twisted pair wires 124 and 126 by way of a suitable communications protocol that facilitates bidirectional communications between the ECU 102 and the ultrasonic sensors 104-122 by way of differential signaling. For example, the communications protocol employs LVDS. In a more specific example, the communications protocol is the A²B protocol, Ethernet, or other suitable protocol that employs differential signaling in connection with enabling bidirectional communication over twisted pair wire.

The architecture depicted in FIG. 1 provides various advantages over conventional architectures associated with ultrasonic sensors in human-operated vehicles. For example, conventionally, ultrasonic sensor systems have star topologies, where an ECU is independently coupled to each of several ultrasonic sensors in a vehicle by four separate wires. Due to the significant amount of cabling in such an architecture, the number of ultrasonic sensors that can be included in a vehicle is limited. By coupling the ECU 102 to the ultrasonic sensors 104-112 and 114-122 in series, the autonomous vehicle 100 may include a much larger number of ultrasonic sensors than what can be included in conventional human-operated vehicles, as the amount of cabling required in the architecture depicted in FIG. 1 is drastically reduced when compared to the amount of cabling used in conventional ultrasonic sensor system architectures.

Further, the communications protocol used in connection with bidirectional communications between the ECU 102 and the ultrasonic sensors 104-122 allow for more data to be transmitted over the twist pair wires 124 and 126 than what is possible in conventional ultrasonic sensor system architectures. Hence, rather than ASICs of the ultrasonic sensors 104-122 being configured to perform cross-correlation computations, the ECU 102 is configured to perform cross-correlation computations. Performance of cross-correlation computations by the ECU 102 is advantageous, as one or more of the ultrasonic sensors 104-122 can be continuously outputting signals to the ECU 102, and the ECU 102 can perform cross-correlation computations for multiple signals output by multiple ultrasonic sensors 104-122 substantially simultaneously, resulting in more data points than what is possible with the conventional architecture.

in addition, the ultrasonic sensors 104-122 can be configured to include, in ultrasonic signals emitted by the ultrasonic sensors 104-122, information that is indicative of identities of the ultrasonic sensors 104-122 that respectively emitted the ultrasonic signals. More specifically, the first ultrasonic sensor 104 is configured to emit a first ultrasonic signal into an environment proximate the autonomous vehicle 100, where the first ultrasonic signal has first information included therein that is indicative of an identity of the first ultrasonic sensor 104. Such information may be a phase shift, a code, etc. Similarly, the second ultrasonic sensor 106 is configured to emit a second ultrasonic signal into the environment proximate the autonomous vehicle 100, where the second ultrasonic signal has second information included therein that is indicative of an identity of the second ultrasonic sensor 106. As noted above, such information may be a phase shift, a code, etc.

The emitted ultrasonic signals may reflect off of an object 128, and the reflected signals retain the information that identifies the ultrasonic sensors that emitted the ultrasonic signals. One or more ultrasonic sensors detects the reflected signals, generates electrical signals that represent the reflected signals, and transmits the generated electrical signals to the ECU 102. The ECU 102 performs cross-correlation computations on the electrical signals, where each of the electrical signals received by the ECU 102 can be cross-correlated by the ECU 102 with several (expected) time-series signals that correspond to the ultrasonic sensors that emitted the ultrasonic signals. This process is advantageous, as the ECU 102 can precisely identify an amount of time between when an ultrasonic sensor emitted an ultrasonic signal and when the corresponding reflected signal was detected by the ultrasonic sensor (or another ultrasonic sensor). Thus, the ECU 102 can precisely identify a distance between the ultrasonic sensor that emitted the ultrasonic signal and the object 128 from which the ultrasonic signal reflected. It is noted that the ECU 102 can compute a more precise distance between the autonomous vehicle 100 and the object 128 than what is possible using conventional approaches, as the additional information in emitted ultrasonic signals causes a fairly narrow peak to be included in the cross-correlation output (much narrower than the peak included in the cross-correlation output when cross-correlating between pulses that lack the additional information referenced above).

Still further, including information that identifies an emitting ultrasonic sensor in the ultrasonic signal emitted thereby results in Doppler information being included in reflected signals, where such Doppler information either is not captured by ultrasonic sensors in conventional architectures or is discarded in conventional ultrasonic sensor system architectures. In the autonomous vehicle 100, the ECU 102 can process signals received from the ultrasonic sensors 104-122 and compute relative velocity between the autonomous vehicle 100 and an object in the environment of the autonomous vehicle 100 (e.g., the object 128).

An example of operation of the autonomous vehicle 100 is now set forth. The second ultrasonic sensor 106 is configured to emit a first ultrasonic signal with first information included therein that identifies the second ultrasonic sensor 106. Similarly, the fourth ultrasonic sensor 110 is configured to emit a second ultrasonic signal that has second information included therein that identifies the fourth ultrasonic sensor 110. For instance, the first ultrasonic signal and the second ultrasonic signal may have a similar frequency. The ECU 102 can cause the second ultrasonic sensor 106 to emit the first ultrasonic signal over a first window of time and can cause the fourth ultrasonic sensor 110 to emit the second ultrasonic signal over a second window of time (which may or may not overlap with the first window of time), The third ultrasonic sensor 108 is configured to continuously monitor the frequency at which the second ultrasonic sensor 106 and the fourth ultrasonic sensor 110 emit ultrasonic signals.

The first ultrasonic signal emitted by the second ultrasonic sensor 106 reflects from the object 128, and thus a first reflected signal is formed. The third ultrasonic sensor 108 detects the first reflected signal and generates a first electrical signal that is representative of the first reflected signal. The third ultrasonic sensor 108 transmits the first electrical signal to the ECU 102 over the first twisted pair wire 124, and the ECU 102 cross-correlates the first electrical signal with a first time-series signal that is representative of the first ultrasonic signal emitted by the second ultrasonic sensor 106. The ECU 102, based upon the performed cross-correlation, can ascertain that the first reflected signal corresponds to the second ultrasonic sensor 106 and can further ascertain a precise amount of time between when the ECU 102 instructed the second ultrasonic sensor 106 to emit the first ultrasonic signal and when the ECU 102 received the first electrical signal.

The second ultrasonic signal emitted by the fourth ultrasonic sensor 110 reflects from the object 128, resulting in a second reflected signal being detected by the third ultrasonic sensor 108. The third ultrasonic sensor 108, upon detecting the second reflected signal, generates a second electrical signal that represents the second reflected signal and transmits the second electrical signal to the ECU 102 over the first twisted pair wire 124. The ECU 102 performs a cross correlation between the second electrical signal and a second time series signal that is representative of the second ultrasonic signal emitted by the fourth ultrasonic sensor 110. Based upon such cross-correlation, the ECU 102 determines (precisely) an amount of time between when the ECU 102 instructed the fourth ultrasonic sensor 110 to emit the second ultrasonic signal and when the second electrical signal was received by the ECU 102. Therefore, the ECU 102 can relatively quickly compute distances between the object 128 and the ultrasonic sensors 106 and 110. Further, the ECU 102 can compute relative velocity between the object 128 and the autonomous vehicle 100 based upon the received electrical signals from the ultrasonic sensors 106-108.

While the example set forth above refer to the ultrasonic sensors 106 and 110 emitting ultrasonic signals having similar frequencies, it is to be understood that the ultrasonic sensors 106 and 110 may emit ultrasonic signals having different frequencies, and two different ultrasonic sensors can detect reflected signals that correspond to the ultrasonic signals emitted by the ultrasonic sensors 106 and 110 (with the two detecting ultrasonic sensors configured to detect reflected signals having the different frequencies). Further, while the autonomous vehicle 100 is illustrated as including ten ultrasonic sensors, it is to be understood that the autonomous vehicle 100 may include many more ultrasonic sensors to allow for 360-degree coverage in the near field of the autonomous vehicle 100. The near field, in an example, may be between zero and two meters from the autonomous vehicle 100. In another example, the near field may be between zero and five meters of the autonomous vehicle 100. In yet another example, the near field may be between zero and fifteen meters from the autonomous vehicle 100.

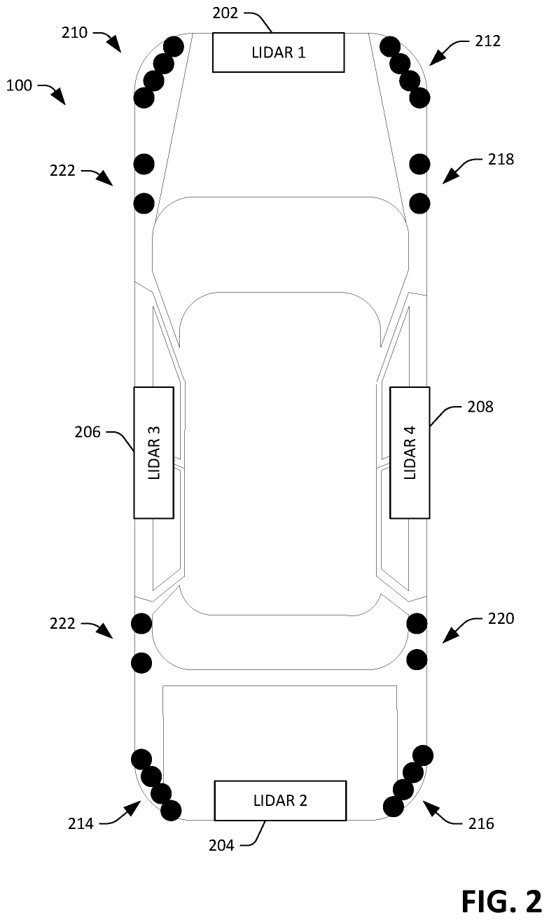

Referring now to FIG. 2, a schematic illustrating the autonomous vehicle 100 is depicted. In the example illustrated in FIG. 2, the autonomous vehicle 100 includes four lidar sensor systems 202-208. The first lidar sensor system 202 and the second lidar sensor system 204 are placed on opposing sides of a lateral axis of the autonomous vehicle 100, and the third lidar sensor system 206 and the fourth lidar sensor system 208 are placed on opposing sides of a longitudinal axis of the autonomous vehicle 100. The autonomous vehicle 100, in this example, includes four dense arrays of ultrasonic sensors 210-216 and for sparse arrays of ultrasonic sensors 218-224, where ultrasonic sensors in the dense arrays are positioned closer to one another than ultrasonic sensors in the sparse arrays. The ultrasonic sensors are positioned around the autonomous vehicle 100 to supplement near-field coverage provided by the lidar sensor systems 202-208. For instance, the dense arrays of ultrasonic sensors 210-216 are positioned at corners of the autonomous vehicle 100, where coverage from the lidar sensor systems 202-208 may be sub-optimal. The sparse arrays of ultrasonic sensors 218-224 are positioned to supplement the lidar sensor systems 206 and 208 to ensure 360 degree near field coverage around the autonomous vehicle 100 (e.g., objects in the near field can be detected anywhere around the autonomous vehicle 100).

Similar to what has been discussed above, ultrasonic sensors in a dense array can each emit ultrasonic signals that have information included therein that identifies the ultrasonic sensors from which the ultrasonic signals were emitted, This is advantageous in that ultrasonic signals emitted by ultrasonic sensors in a dense array may reflect from multiple different points on a scattering object. Based upon cross-correlations performed by the ECU 102, the 102 can control the ultrasonic sensors in the dense array to direct beams of ultrasonic energy to particular positions in space, and/or listen in specific directions, such that location of edges of the scattering object can be identified relative to the autonomous vehicle 100. Again, this allows for more granular determination of position of a scattering object relative to the autonomous vehicle 100 as well as type of the scattering object when compared to what is possible using conventional ultrasonic sensor system architectures in human-operated vehicles.

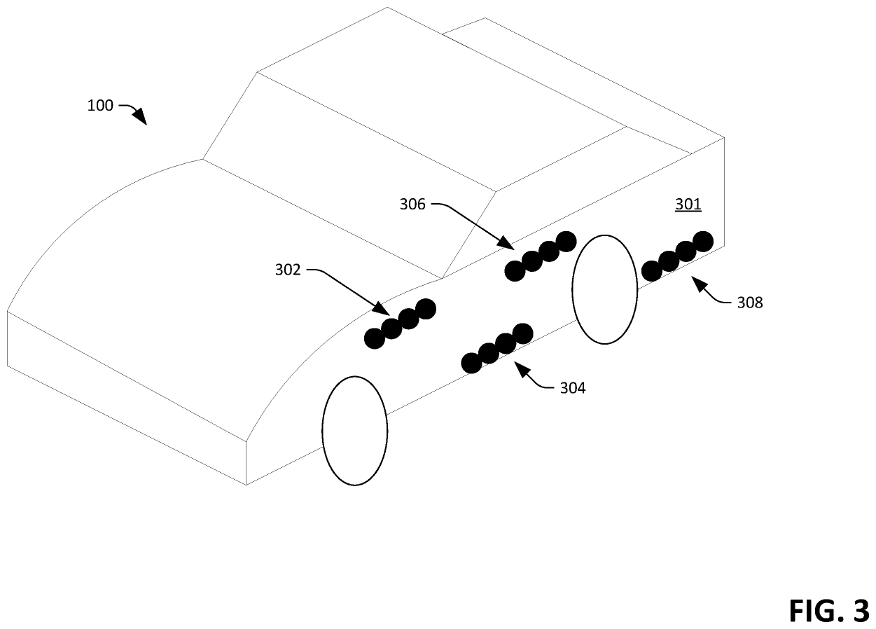

Referring now to FIG. 3, an isometric view of the autonomous vehicle 100 is depicted. The autonomous vehicle 100 includes several arrays of ultrasonic sensors positioned on a side 301 of the ultrasonic vehicle 100. The arrays of ultrasonic sensors include a first array 302, a second array 304, a third array 306, and a fourth array 308. The first array 302 is horizontally and vertically offset from the second array 304 and the fourth array 308 on the side 301 of the autonomous vehicle, and the first array 302 is horizontally offset from the third array 306 but is vertically aligned with the third array 306 along the side 301 of the autonomous vehicle 100. The second array 304 is horizontally and vertically offset from the third array 306 and horizontally offset from the fourth array 308 (but is vertically aligned with the fourth array 308). The example arrangement of arrays depicted in FIG. 3 is set forth to illustrate that arrays of ultrasonic sensors can be placed in a zigzag pattern around a periphery of the autonomous vehicle 100. Other placements of ultrasonic sensor arrays are contemplated. Another example is a distribution of a combination of two types of sensors, one sensor being a dense arrangement of transducers in a grid or spiral, and a second sensor having relatively fewer transducers, with both sensors types placed at several locations around the vehicle.

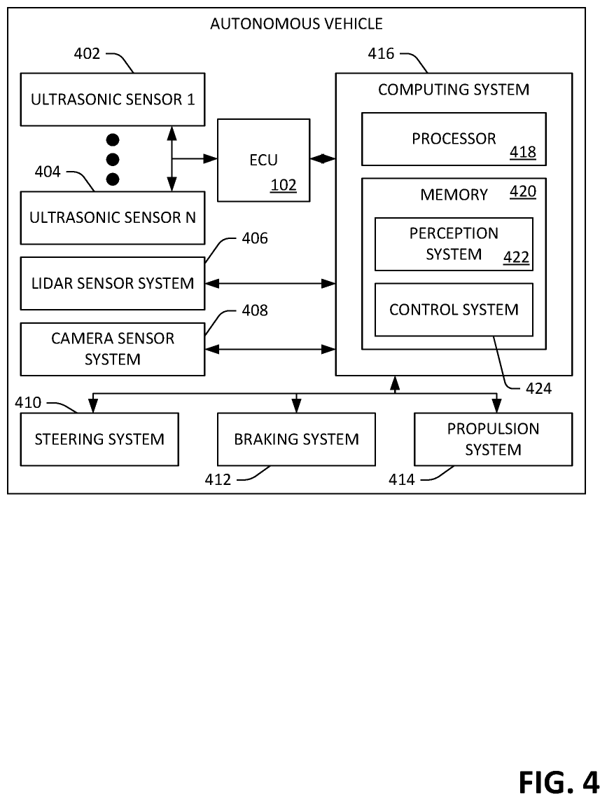

Now referring to FIG. 4, a functional block diagram of the autonomous vehicle 100 is illustrated. The autonomous vehicle 100 includes ultrasonic sensors 402-404 and the ECU 102, where the ultrasonic sensors 402-404 are electrically coupled in series to the ECU 102 and to one another by way of a twisted pair wire (as described above). The autonomous vehicle 100 further includes a lidar sensor system 406 and a camera sensor system 408. The camera sensor system 408 is configured to capture images of an environment surrounding the autonomous vehicle 100, while the lidar sensor system 406 is configured to construct a 3-dimensional point cloud of the environment surrounding the autonomous vehicle 100.

The autonomous vehicle 100 further includes several mechanical systems. The mechanical systems include a steering system 410, a braking system 412, and a propulsion system 414. The steering system 410 is configured to control direction of motion of the autonomous vehicle 100. The braking system 412 is configured to decelerate the autonomous vehicle 100. The propulsion system 414 is configured to propel the autonomous vehicle 100 in a direction, where the propulsion system 414 may be or include an electric motor or a combustion engine.

The autonomous vehicle 100 also includes a computing system 416 that is operably coupled to the ECU 102, the lidar sensor system 406, the camera sensor system 408, and the mechanical systems 410-414. The computing system 416 includes a processor 418 and memory 420 that includes instructions that are executed by the processor 418. The processor 418 can include any suitable type of processing circuitry, including but not limited to a central processing unit (CPU), a graphics processing unit (GPU), a field programmable gate array (FPGA), a microcontroller, a microprocessor, etc. The memory 420 includes a perception system 422 and a control system 424 that are executed by the processor 418. The perception system 422 is configured to receive outputs from the ECU 102, the lidar sensor system 406, and the camera sensor system 408, and is further configured to identify and track objects in the environment of the autonomous vehicle 100 based upon such outputs. For instance, the perception system 422 may include any suitable algorithms and/or computer implemented models to identify and track objects in the environment of the autonomous vehicle 100. Accordingly, the perception system 422 may include a Bayesian Network, a Deep Neural Network (DNN), a Recurrent Neural Network (RNN), or other suitable model/algorithm.

The control system 424 receives output of the perception system 422 and controls at least one of the steering system 410, the braking system 412, or the propulsion system 414 based upon outputs of the perception system 422. In a non-limiting example, the perception system 422 can receive output of the ECU 102 that indicates that an object is proximate a forward bumper on a first side of the autonomous vehicle 100. The perception system 422 determines that the object is a static traffic cone and can output an indication to the control system 424 that a traffic cone is proximate the forward bumper of the autonomous vehicle 100 on a first side of the autonomous vehicle 100. The control system 424 controls the steering system 410 and the propulsion system 414 to cause the autonomous vehicle 100 to avoid the cone while continuing to navigate a roadway.

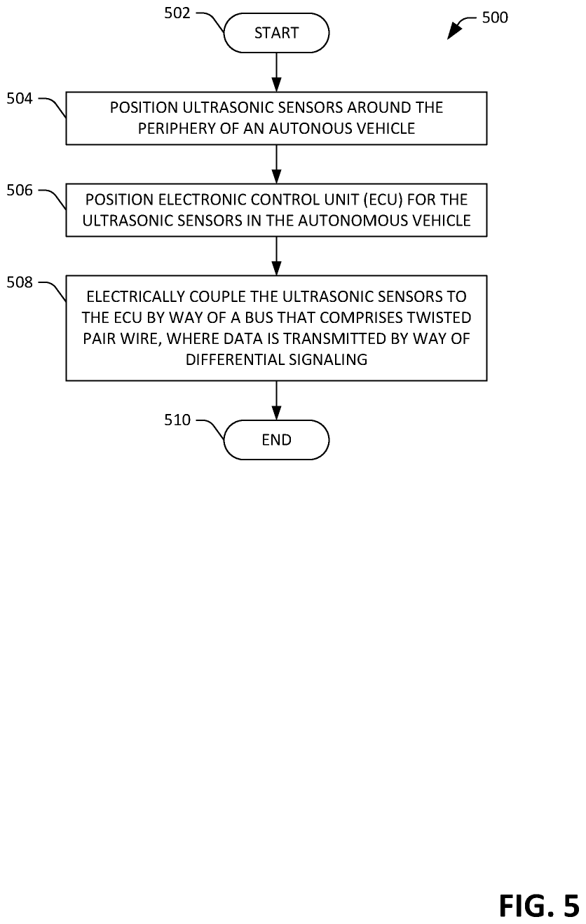

FIGS. 5-7 illustrate methodologies relating to ultrasonic sensor systems of an autonomous vehicle. While the methodologies are shown and described as being a series of acts that are performed in a sequence, it is to be understood and appreciated that the methodology is not limited by the order of the sequence. For example, some acts can occur in a different order than what is described herein. In addition, an act can occur concurrently with another act. Further, in some instances, not all acts may be required to implement the methodology described herein.

Moreover, some of the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

Referring solely to FIG. 5, a methodology 500 for electrically coupling ultrasonic sensors and a corresponding ECU in an autonomous vehicle is illustrated. The methodology 500 starts at 502, and at 504 ultrasonic sensors are positioned around the periphery of the autonomous vehicle. As described previously, the ultrasonic sensors may be included in dense arrays of ultrasonic sensors and/or sparse arrays of ultrasonic sensors.

At 504, an ECU for the ultrasonic sensors is positioned in the autonomous vehicle. At 506, the ultrasonic sensors are electrically coupled to the ECU by way of a bus that comprises a twisted pair wire, where data is transmitted between the ECU and the ultrasonic sensors over the twisted pair wire by way of differential signaling. The methodology 500 completes at 510.

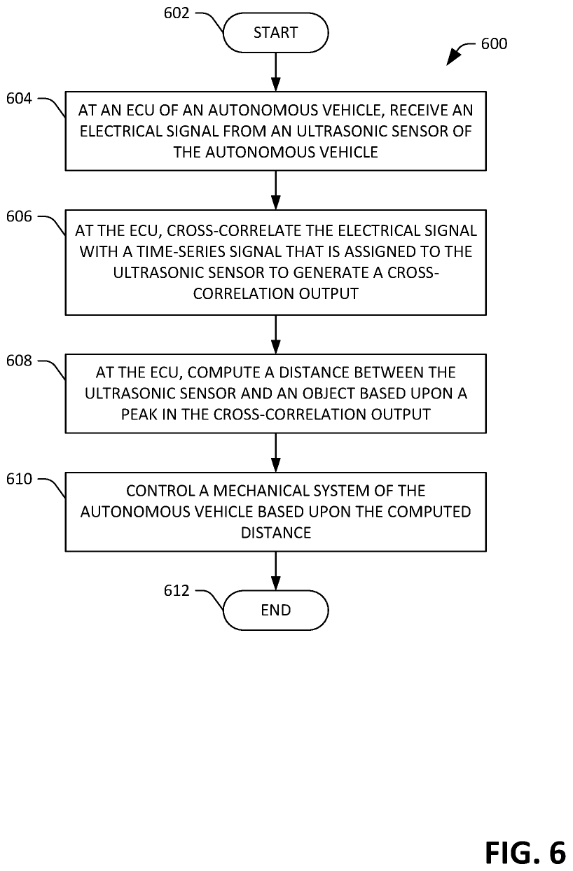

With reference now to FIG. 6, a flow diagram illustrating an exemplary methodology 600 for controlling a mechanical system of an autonomous vehicle based upon output of an ultrasonic sensor of the autonomous vehicle is illustrated. The methodology 600 starts at 602, and at 604, at an ECU of an autonomous vehicle, an electrical signal from an ultrasonic sensor of the autonomous vehicle is received. The electrical signal is representative of a reflected signal detected by the ultrasonic sensor, where the reflected signal is formed upon an ultrasonic signal emitted by the ultrasonic sensor or a second ultrasonic sensor.

At 606, at the ECU, the electrical signal is cross-correlated with a time-series signal that is assigned to the ultrasonic sensor that emitted the ultrasonic signal, whereupon the ECU generates a cross-correlation output. As indicated previously, the reflected signal can include information that allows identification of which ultrasonic sensor emitted the ultrasonic signal reflected from an object. The time-series signal used by the ECU to perform the cross-correlation with the electrical signal may be representative of the ultrasonic signal emitted into the environment of the autonomous vehicle.

At 608, at the ECU, a distance between the emitting ultrasonic sensor and the object is computed based upon a peak identified in the cross-correlation output produced by the ECU. Such peak can identify an amount of time between when the ECU instructed the emitting ultrasonic sensor to emit the ultrasonic signal and when the electrical signal was received by the ECU.

At 610, by a computing system of the autonomous vehicle, a mechanical system of the autonomous vehicle is controlled based upon the distance computed at 608. For instance, any of a steering system, a braking system, or a propulsion system may be controlled based upon the distance computed at 608. The methodology 600 completes at 612.

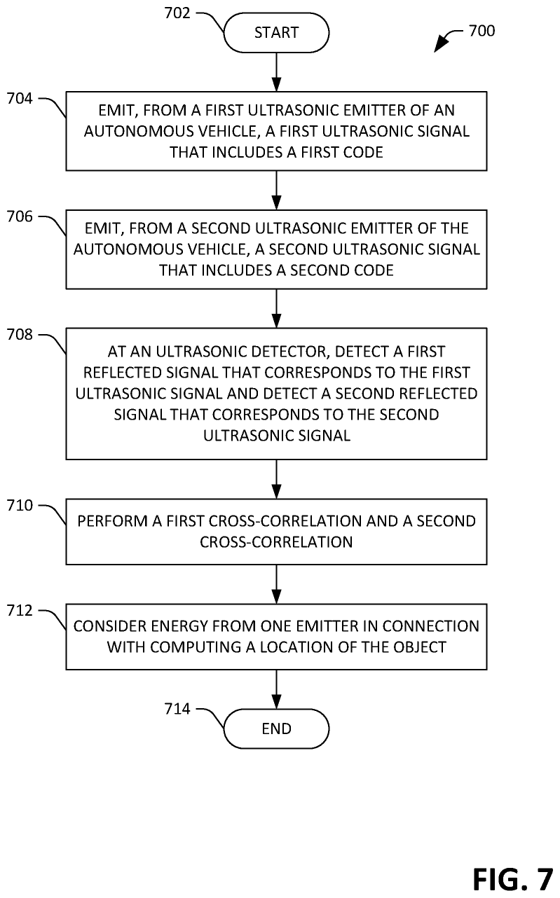

Referring now to FIG. 7, a flow diagram illustrating an exemplary methodology 700 for directing a beam of ultrasonic energy towards an object in an environment of an autonomous vehicle is illustrated. The methodology starts at 702, and at 704 a first ultrasonic signal that includes a first code is emitted from a first ultrasonic emitter of an autonomous vehicle. The first code may be unique to the first ultrasonic emitter.

At 706 a second ultrasonic signal is emitted from a second ultrasonic emitter of the autonomous vehicle, where the second ultrasonic signal includes a second code. The second code may be unique to the second ultrasonic emitter.

At 708 at an ultrasonic transducer receives a superposition of the signals transmitted by the first and second ultrasonic emitters. This signal is transmitted to the ECU.

At 710, the ECU performs a first cross-correlation (or similar) in order to separate out the data transmitted by the first emitter, and performs a second cross-correlation (or similar) in order to separate out the signal transmitted by the second emitter. The first cross-correlation (or similar) is performed with respect to the first electrical signal and a first time-series signal assigned to the first ultrasonic emitter, and the second cross-correlation (or similar) is performed with respect to the second electrical signal and a second time-series signal that is assigned to the second ultrasonic emitter. Some examples of approaches similar to cross correlation are covariance or coherence, which may also be used to isolate energy from emitters.

At 712, in the ECU after having isolated energy originating from each emitter at each receiver, energy from one emitter can be considered. Delays or other spatial filtering can then be applied to the signals at each receiver (for that single emitter) to determine how much energy came from each direction. Thus the object's location and shape may be calculated. Ground reflections may be rejected. The methodology 700 completes at 714.

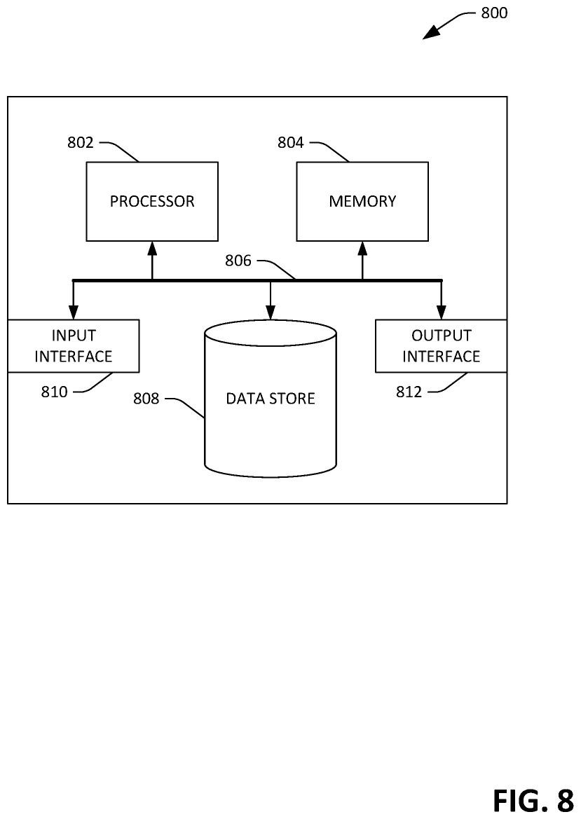

Referring now to FIG. 8, a high-level illustration of an exemplary computing device 800 that can be used in accordance with the systems and methodologies disclosed herein is illustrated. For instance, the computing device 80. may be used in a system that is configured to control a mechanical system of an autonomous vehicle. By way of another example, the computing device 800 can be used in a system that is configured to perform cross-correlations with respect to two time-series signals. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store cross-correlation outputs, ultrasonic sensor outputs, calibration settings, parameters etc.

The computing device 800 additionally includes a data store 808 that is accessible by the processor 802 by way of the system bus 806. The data store 808 may include executable instructions, cross-correlation values, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components, For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the details description or the claims, such term is intended to be inclusive in a manner similar to the term “comprising” as “comprising” is interpreted when employed as a transitional word in a claim.

What is claimed is:

1. An autonomous vehicle, comprising:
a first ultrasonic sensor;
a second ultrasonic sensor that is included in a daisy chain with the first ultrasonic sensor, wherein the first ultrasonic sensor is electrically connected to the second ultrasonic sensor in the daisy chain by way of a twisted pair wire; and
an electronic control unit (ECU) for the first ultrasonic sensor and the second ultrasonic sensor, the ECU is included in the daisy chain with the first ultrasonic sensor and the second ultrasonic sensor, wherein the ECU is electrically connected to the first ultrasonic sensor and the second ultrasonic sensor by way of the twisted pair wire, and further wherein the ECU is in bidirectional communication with the first ultrasonic sensor and the second ultrasonic sensor by way of differential signaling over the twisted pair wire.

7. The autonomous vehicle of claim 1, further comprising:
a third ultrasonic sensor that is included in the daisy chain with the first ultrasonic sensor, the second ultrasonic sensor, and the third ultrasonic sensor, wherein the first ultrasonic sensor, the second ultrasonic sensor, and the third ultrasonic sensor are adjacent to one another in the daisy chain and are electrically coupled in series with one another.

3. The autonomous vehicle of claim 1, wherein:
the first ultrasonic sensor is configured to output an electrical signal to the ECU, wherein the electrical signal is indicative of existence of an object in an environment of the autonomous vehicle; and
the ECU is configured to cross-correlate the first electrical signal with a first time-series signal assigned to the first ultrasonic sensor to generate an output, wherein the output is indicative of a distance between the object and the first ultrasonic sensor of the autonomous vehicle.

4. The autonomous vehicle of claim 1, wherein:
the first ultrasonic sensor is configured to emit a first ultrasonic signal with a first code therein; and
the second ultrasonic sensor is configured to emit a second ultrasonic signal with a second code therein, wherein the second code is different from the first code

5. The autonomous vehicle of claim 4, wherein the ECU is further configured to:
receive a first electrical signal from a third ultrasonic sensor, wherein the first electrical signal is based upon the first ultrasonic signal;
receive a second electrical signal from the third ultrasonic sensor, wherein the second electrical signal is based upon the second ultrasonic signal; and
compute a location of an object relative to the autonomous vehicle based upon the first electrical signal and the second electrical signal.

6. The autonomous vehicle of claim 1, wherein the first ultrasonic sensor is included in a first array of ultrasonic sensors, and the second ultrasonic sensor is included in a second array of ultrasonic sensors that is separate from the first array of ultrasonic sensors.

7. The autonomous vehicle of claim 6, wherein the first array of ultrasonic sensors and the second array of ultrasonic sensors are vertically displaced from one another on a periphery of the autonomous vehicle.

8. The autonomous vehicle of claim 1, further comprising:
a computing system that is in communication with the ECU and is configured to receive output of the ECU, wherein the output of the ECU is based upon at least one signal output by at least one of the first ultrasonic sensor or the second ultrasonic sensor; and
a mechanical system that is operably coupled to the computing system, wherein the computing system is configured to control the mechanical system based upon the output of the ECU.

9. The autonomous vehicle of claim 8, further comprising:
a lidar sensor system that is operably coupled to the computing system, wherein the computing system is configured to control the mechanical system based further upon the output of the lidar sensor system.

10. The autonomous vehicle of claim 1, wherein the ECU is in bidirectional communication with the first ultrasonic sensor and the second ultrasonic sensor by way of low voltage differential signaling (LVDS) over the twisted pair wire.

11. The autonomous vehicle of claim 1, wherein the ECU is in bidirectional communication with the first ultrasonic sensor and the second ultrasonic sensor by way of A²B over the twisted pair wire.

12. A method for configuring an autonomous vehicle, the method comprising:
positioning ultrasonic sensors around a periphery of the autonomous vehicle;
positioning an electronic control unit (ECU) for the ultrasonic sensors in the autonomous vehicle; and
electrically coupling the ultrasonic sensors to the ECU by way of a bus that comprises a twisted pair wire, where the several ultrasonic sensors are coupled to one another electrically in series and are further electrically coupled to the ECU in series, and further wherein data is transmitted over the bus by way of differential signaling.

13. The method of claim 12, wherein the data is transmitted over the bus by way of low voltage differential signaling (LVDS).

14. The method of claim 12, wherein the data is transmitted over the bus by way of Ethernet.

15. The method of claim 12, wherein the data is transmitted over the bus by way of the A²13 protocol.

16. The method of claim 12, wherein the ultrasonic sensors include a first ultrasonic sensor and a second ultrasonic sensor, and further wherein the first ultrasonic sensor is included in a first array of ultrasonic sensors and the second ultrasonic sensor is included in a second array of ultrasonic sensors.

17. The method of claim 16, wherein the first ultrasonic sensor is positioned on a first side of a longitudinal axis of the autonomous vehicle and the second ultrasonic sensor is positioned on a second side of the longitudinal axis of the autonomous vehicle, and further wherein the first side is opposite the second side.

18. An autonomous vehicle comprising:
an ultrasonic sensor that is configured to generate an electrical signal;
an electronic control unit (ECU) for the ultrasonic sensor, wherein the ECU is electrically coupled to the first ultrasonic sensor and is configured to:
perform a cross-correlation of the electrical signal with a time-series signal assigned to the ultrasonic sensor; and
generate a correlation output based upon the cross-correlation;
a mechanical system; and
a computing system that is operably coupled to the ECU and the mechanical system, wherein the computing system is configured to control the mechanical system based upon the correlation output generated by the ECU.

19. The autonomous vehicle of claim 18, wherein the ECU is configured to compute a location of an object relative to the autonomous vehicle based upon the correlation output, and further wherein the computing system is configured to control the mechanical system based upon the location of the object computed by the ECU.

20. The autonomous vehicle of claim 18, wherein the ultrasonic sensor and the ECU are electrically coupled to one another in a daisy chain, wherein the ECU is in bidirectional communication with the ultrasonic sensor by way of a twisted pair wire, and further wherein data is transmitted over the twisted pair wire by way of differential signaling.
